(19) United States
(12) Patent Application Publication
(10) Pub. No.: US 2003/0006969 A1
(43) Pub. Date: Jan. 9, 2003

(54) System for one-touch bible book selection and viewing

(76) Inventor: Bryan L. Barras, Chino Valley, AZ (US)

Correspondence Address: STONEMAN LAW OFFICES, LTD, 3113 NORTH 3RD STREET, PHOENIX, AZ, 85012, US

(21) Appl. No.: 10/150,124

(22) Filed: May 16, 2002

Related U.S. Application Data
(60) Provisional application No. 60/291,543, filed on May 16, 2001.

(51) Int. Cl. G09G 5/00

(52) U.S. Cl. 345/169

(57) ABSTRACT

A hand-held system for user selection and display of electronically stored Biblical information. More specifically, a portable electronic bible system having a Bible book selection keypad with dedicated Bible book keys to provide one-touch Bible book selection and viewing. The system comprises additional keys for selection of a desired chapter and verse. Biblical and menu information is viewed on an LCD display. The system is battery powered with an optional A/C adapter. A data transfer port allows supplemental Biblical information to be transferred and stored in the memory of the system. System components are contained in a two-part hinged housing. A method of use and methods of acquiring supplemental Biblical information are also described.

### CROSS-REFERENCE TO RELATED APPLICATION

The present application is related to applicant's prior U.S. Provisional Application No. 60/291,543, filed May 16, 2001, entitled “ONE-TOUCH BIBLE BOOK SELECTION AND VIEWING SYSTEM”, the contents of which are herein incorporated by reference and are not admitted to be prior art with respect to the present invention by their mention in this cross-reference section.

### BACKGROUND

This invention relates to a portable bible study system. More specifically, this invention provides a portable electronic bible system having the feature of providing one-touch bible book selection and viewing for quickly and easily reading and studying the bible.

The most commonly used translations of the Christian Bible contain an organizational structure of 66 books, 1189 chapters and over 31,000 verses. Reading and studying the vast volume of material contained within the Bible is an endeavor undertaken by an ever-increasing percentage of the world's population. An individual who wishes to view and study bible scripture by book, chapter and verse has a limited number of options. Historically, reading one or more bible passages has required a person to laboriously search, page by page, through a conventional printed bible. The advent of computers and similar electronic devices has provided additional means for accessing biblical text information; however, despite having the potential for increased convenience, these devices have not been adapted to meet the requirements of the typical bible reader.

A useful study bible has a number of preferred features and characteristics. The majority of bible readers study within an organized group within a set timeframe (e.g., a Sunday worship service held at a local church). A highly desirable feature of a study bible is therefore portability, allowing the reader to transport the text between home, the group study venue and the worship venue (in the printed bible, a very thin paper, often referred to as bible paper, was developed to specifically address the issue of portability). A second highly desirable feature of a study bible is its ease of use, specifically, the ability of a user to quickly locate a desired passage of biblical text. In the past, printed bibles have employed such search aides as thumb indexes comprising a series of rounded notches cut into the fore edge of the book. Each notch generally has a label bearing letters indicating the respective book of the bible. In electronic systems, a clearly defined, dedicated input interface that minimizes the number of user inputs required to locate and display a specific biblical book and passage is a highly desirable feature. Currently, no electronic biblical text system provides the combined features of portability with an efficient and functionally dedicated input interface.

Based on the above discussion, a need exists for a small, portable electronic bible system that is easy to use and provides simple and fast access of the scripture for the reader. Another need exists for a small, portable electronic bible system that has quick one-button access to the books of the bible.

### OBJECTS OF THE INVENTION

A primary object and feature of the present invention is to provide a portable electronic bible system that is easy to use and provides simple and fast access of the scripture for the reader. Another primary object and feature of the present invention is to provide such a small, portable electronic bible system that has quick dedicated button access to the books of the bible by a single user actuation. A further primary object and feature of the present invention is to provide such a small, portable electronic bible system that does not require the complete and accurate inputting of the bible book, chapter and verse of interest. Yet another primary object and feature of the present invention is to provide such a system that allows one or more translations of the bible to be downloaded to the device. In addition, other objects and features of this invention will become apparent with reference to the following invention descriptions.

### SUMMARY OF THE INVENTION

In accordance with a preferred embodiment of the present invention, this invention provides a system for user selection and display of electronically stored Biblical information comprising: at least one storage component structured and arranged to electronically store the Biblical information; at least one input component structured and arranged to assist user input; at least one display component structured and arranged to display the electronically stored Biblical information; and at least one processor component structured and arranged to: process at least one signal from such at least one input component; retrieve a user-selected portion of electronically stored Biblical information from such at least one storage component; and display the user-selected portion of electronically stored Biblical information on such at least one display component; at least one hand-holdable housing structured and arranged to house such at least one storage component, such at least one input component, such at least one processor component and such at least one display component; wherein such at least one input component comprises a plurality of dedicated actuators; wherein each respective such dedicated actuator is structured and arranged to select a single respective one bible book by a single user actuation; and wherein each such dedicated actuator selects one of 66 bible books for display.

Additionally, it provides such a system comprising: at least one chapter selection component structured and arranged to assist user selection of at least one chapter of at least one electronically stored bible book; and at least one verse selection component structured and arranged to assist user selection of at least one verse of at least one chapter of at least one electronically stored bible book. Further, it provides such a system comprising: at least one user entry recording component structured and arranged to electronically record at least one string of sequential user entries; and at least one toggle selection component structured and arranged to assist the user in sequentially toggling between displays of the electronically recorded entries of the at least one string of sequential user entries.

Moreover, it provides such a system comprising at least one numeric input component structured and arranged to assist user numeric input of at least one chapter and at least one verse of at least one electronically stored bible book. Additionally, it provides such a system further comprising at least one data-transferring component structured and arranged to transfer electronic Biblical information, contained within at least one separate electronic device, to such system.

It further provides such a system comprising: at least one verse selection component structured and arranged to assist user selection of at least one verse of at least one chapter of at least one electronically stored bible book; at least one user entry recording component structured and arranged to electronically record at least one string of sequential user entries; at least one toggle selection component structured and arranged to assist the user in sequentially toggling between displays of the electronically recorded entries of the at least one string of sequential user entries; at least one numeric input component structured and arranged to assist user numeric input of at least one chapter and at least one verse of at least one electronically stored bible book; and at least one data-transferring component structured and arranged to transfer electronic biblical data, contained within at least one separate electronic device, to such system.

In addition, it provides such a system wherein such at least one hand-holdable housing further comprises: at least one front housing section; at least one rear housing section; and at least one pivot structured and arranged to pivotally join such at least one front housing section to such at least one rear housing section. It further provides such a system comprising at least one power supply structured and arranged to supply power to such system. Additionally, it provides such a system wherein such at least one power supply comprises at least one on-board battery to assist in portability. Further, it provides such a system wherein such at least one power supply comprises at least one A/C adapter. Even further, it provides such a system comprising at least one power controller structured and arranged to control the power of such system.

Additionally, it provides such a system wherein such at least one power controller comprises: at least one user controlled switch; and at least one automatic switch controlled by such at least one processor; wherein such at least one processor, on detecting a predefined period of inactive use of such system, opens such automatic switch to conserve capacity of such at least one power supply. Moreover, it provides such a system wherein such at least one display comprises: at least one text display area structured and arranged to display the selected electronic Biblical information; at least one displayed book identifier area structured and arranged to identify the selected biblical book; at least one displayed chapter identifier area structured and arranged to identify at least one selected chapter of at least one selected biblical book; and at least one displayed verse identifier area structured and arranged to identify at least one selected verse of at least one selected chapter of at least one selected biblical book. Furthermore, it provides such a system wherein: such at least one dedicated actuator comprises at least one key comprising at least one membrane switch and wherein: such at least one chapter selection component comprises at least one scrollable key; and such at least one verse selection component comprises at least one scrollable key.

In accordance with another preferred embodiment hereof, this invention provides a method of using a system for user selection and display of electronically stored Biblical information comprising the steps of: selecting a bible version from a displayed list; and selecting a bible book by performing a user input, using a dedicated selection actuator, whereby the selected bible book is displayed. Further, it provides such a method further comprising: selecting a desired bible chapter by performing at least one user input, using at least one scrollable bible chapter selection component, whereby the selected bible chapter is displayed; and selecting a desired bible verse by performing at least one user input, using at least one scrollable bible verse selection component, whereby the selected bible book is displayed. Additionally, it provides such a method further comprising: selecting a desired bible chapter and verse by performing at least one user input, using at least one numeric input component, whereby the selected bible chapter and verse are displayed.

In accordance with another preferred embodiment hereof, this invention provides a method for acquiring at least one supplemental electronic copy of Biblical information for storage and use with at least one system for user selection and display of electronically stored Biblical information, comprising the steps of: at least one transaction with at least one electronic Biblical information source to acquire such at least one electronic copy of Biblical information; receiving such at least one electronic copy of Biblical information for storage on at least one separate electronic device; and transferring such at least one electronic copy of biblical data, contained within such at least one separate electronic device, to such system. In addition, it provides such a method wherein: such at least one transaction comprises at least one retail purchase of at least one electronic copy of Biblical information; and such at least one electronic copy of Biblical information comprises at least one electronic storage media. Further, it provides such a method wherein: such at least one transaction comprises at least one Internet-based purchase of such at least one electronic copy of Biblical information; and such at least one electronic copy of Biblical information is electronically transferred, from at least one Internet-based site, to such at least one separate electronic device.

### BRIEF DESCRIPTION OF THE DRAWINGS

FIG. 1 is a perspective view of a preferred embodiment of the system for one-touch bible book selection and viewing, held in an open position by a user according to a preferred embodiment of the present invention.

FIG. 2 is a front interior view of the system according to a preferred embodiment of the present invention.

FIG. 3 is a front view of the system, in a closed position, according to a preferred embodiment of the present invention.

FIG. 4 is a side view of the system, in a closed position, according to a preferred embodiment of the present invention.

FIG. 5 is a rear view of the system, in a closed position, according to a preferred embodiment of the present invention.

FIG. 6 is a partial perspective view of the system showing the case hinge assembly according to a preferred embodiment of the present invention.

FIG. 7 is a preferred component layout and electrical schematic diagram of a portion of the system, including the microprocessor and its display, keypad and nonvolatile memory, according to a preferred embodiment of the present invention.

FIG. 8 is a diagram showing the preferred methods a system user may use to download and install additional biblical text translations according to a preferred embodiment of the present invention.

### DETAILED DESCRIPTION OF A PREFERRED EMBODIMENT OF THE INVENTION

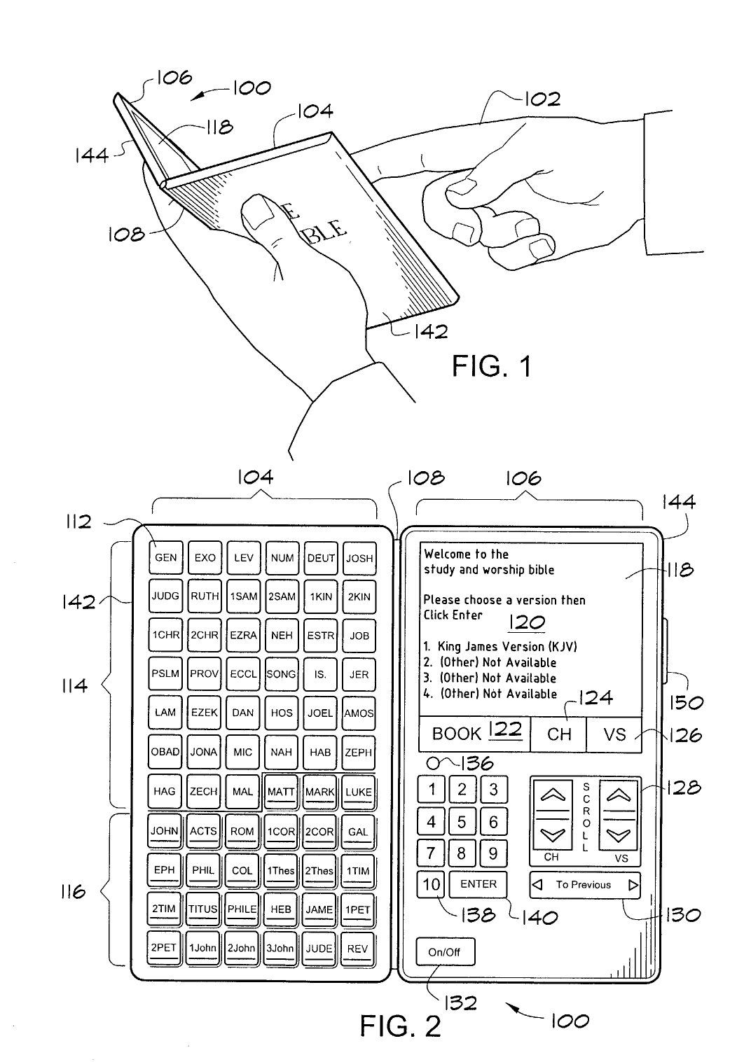

Referring to the drawings, FIG. 1 is a perspective view of a preferred embodiment of the system for one-touch bible book selection and viewing (hereinafter referred to as “system 100”), held in an open position by a user 102 according to a preferred embodiment of the present invention.

System 100 is a small, handheld electronic bible having the preferred feature of portability due to its small size, weight and battery capable operation. System 100 preferably comprises at least two sections, the book selection section 104, and the display and control section 106, as shown. The book selection section 104 and display and control section 106 are preferably joined with at least one hinge assembly 108, as shown. The hinge assembly 108 allows the system 100 to open and close in a manner similar to a printed book. In an open position, the inner surfaces of sections 104 and 106 are accessible to the user 102, as shown. The hinge feature also allows sections 104 and 106 to pivot to a closed position, thereby protecting inner surfaces of sections 104 and 106 from damage.

FIG. 2 is a front interior view of system 100 according to a preferred embodiment of the present invention. Shown in FIG. 2 are the interior surfaces 110 of the book selection section 104, and the display and control section 106, as shown. Preferably, book selection section 104 further comprises a plurality of book selection keys 112 (herein embodying at least one input component structured and arranged to assist user input and herein embodying a plurality of dedicated actuators wherein each respective such dedicated actuator is structured and arranged to select a single respective one Bible book by a single user actuation), as shown. Each of the book selection keys 112 correspond to one of the sixty-six books of The Bible and are labeled with the name of, or an abbreviation of, the name representing such book. For example, “GEN” represents The Book of Genesis, while “MATT” corresponds to The Book of Matthew, etc. The upper half of the book selection keys 112 preferably comprises The Old Testament book keys 114, and the lower half preferably comprises The New Testament book keys 116. Thus, the books of The Bible represented by the book selection keys 112 are comprised in the following table:

| Old Testament: | | |
|---|---|---|
| Genesis | II Chronicles | Daniel |
| Exodus | Ezra | Hosea |
| Leviticus | Nehemiah | Joel |
| Numbers | Esther | Amos |
| Deuteronomy | Job | Obadiah |
| Joshua | Psalms | Jonah |
| Judges | Proverbs | Micah |
| Ruth | Ecclesiastes | Nahum |
| I Samuel | Song of Solomon | Habakkuk |
| II Samuel | Isaiah | Zephaniah |
| 1 Kings | Jeremiah | Haggai |
| 2 Kings | Lamentations | Zechariah |
| I Chronicles | Ezekiel | Malachi |
| New Testament: | | |
| Matthew | Ephesians | Hebrews |
| Mark | Philippians | James |
| Luke | Colossians | I Peter |
| John | I Thessalonians | II Peter |
| Acts | II Thessalonians | I John |
| Romans | I Timothy | II John |
| I Corinthians | II Timothy | III John |
| II Corinthians | Titus | Jude |
| Galatians | Philemon | Revelation |

It should also be noted that an alternate preferred embodiment of the present invention comprises the books of The Apocrypha. In such an alternate preferred embodiment of the present invention, the book selection keys 112 would so reflect those books.

The plurality of book selection keys 112 provides the preferred feature of one-touch button access to any book of The Bible. By preferably providing a single dedicated button assigned to the selection of a single book of The Bible, system 100 provides the user with a clear and efficient means for locating and viewing Bible scripture.

Preferably, the book selection keys 112 are color contrasted to assist the user in their identification. In a preferred embodiment of the present invention, The Old Testament book keys 114 preferably comprise a light green field color with black letters, while The New Testament book keys 116 preferably comprise red keys with black letters. Furthermore, the remaining keys of system 100 are preferably light gray with black lettering to provide additional contrast to ease the user in identification of function. Those skilled in the art will recognize that other color combinations may be preferred under appropriate circumstances.

The display and control section 106 preferably comprises at least one backlit liquid crystal display screen 118 (herein embodying at least one display component structured and arranged to display the electronically stored Biblical information), although those skilled in the art will recognize that under appropriate circumstances, other display screens, such as thin-film transistor, or similar small format displays, may be utilized in preferred embodiments. The display screen 118 preferably comprises at least one, preferably four, text display sections: at least one text display area 120, at least one displayed book identifier 122, at least one displayed chapter identifier 124, and at least one displayed verse identifier 126. The display and control section 106 further preferably comprises one or more scroll control keys 128 (herein embodying at least one chapter selection component and herein embodying at least one verse selection component) that function to increment or decrement the bible chapter and verse displayed upon the liquid crystal display screen 118. The display and control section 106 further preferably comprises at least one jump control switch 130. The preferred function of jump control switch 130 (herein embodying at least one user entry recording component structured and arranged to electronically record at least one string of sequential user entries; and at least one toggle selection component structured and arranged to assist the user in sequentially toggling between displays of the electronically recorded entries of the at least one string of sequential user entries) is to allow the user to toggle between previously selected text passages. As one example, a user selects and views an Old Testament verse, and then selects and views a New Testament verse, the user may then toggle between the two selections with a single touch of the jump control switch 130. A record of the user's selections during use is preferably stored in the memory of system 100 until the unit is turned off, or the user clears the memory through a predefined selection of keystrokes. The number of user selections recorded and stored may range from less than ten to several hundred or more, depending on the unit model and the memory capacity supplied to a system 100 during manufacture. It should be noted that under appropriate circumstances, an embodiment of the present invention may allow the user's selection record to be stored in nonvolatile memory to retain the record for a period of time after the unit is turned off or the batteries have been removed from the unit. The preferred arrangement of scroll control keys 128 in combination with the jump control switch 130 provides the user with a scripture navigation and selection interface having selections and jumps requiring only single button action by the user. This preferred feature makes embodiments of the present invention highly efficient in locating and viewing Bible scripture.

The display and control section 106 further preferably comprises at least one power on/off switch 132. The power on/off switch 132 preferably functions to allow the user to manually turn on and off system 100, although system 100 further preferably comprises an automatic power off feature that will power-down system 100 after a pre-determined length of time to preserve battery capacity. This feature may optionally be disabled when an AC adapter 134 is supplying power to the system 100 (as shown in FIG. 5).

Preferably, the display and control section 106 further comprises at least one power indicator 136, as shown. The power indicator 136 preferably functions to indicate the ON/OFF status of system 100, and may preferably further indicate the status of the battery capacity supplying system 100. The display and control section 106 further preferably comprises at least one numeric keypad 138 (herein embodying at least one numeric input component), as shown. The numeric keypad 138 preferably comprises numbered keys 0-9 that are used to enter a user selection. For example, system 100 is preferably adapted to store one or more of the following Bible versions: New International Version, New American Standard Bible, King James Version, New King James Version, NIV formatted (New Testament), Revised Standard Version, Darby Translation, Young's Literal Translation, Worldwide English (New Testament), 21st Century King James Version, etc. A user of the system 100 is preferably presented with a choice of versions at the start-up of system 100 and may select a preferred Bible version by pressing the associated version number on the numeric keypad 138 followed by pressing the enter key 140 on the numeric keypad 138. It is presently preferred that system 100 be supplied to a user having, initially, a single version of The Bible; the user may subsequently add additional versions, preferably via an electronic coupling, such as a USB port attached to a desktop computer or similar electronic device.

Following the selection of a desired bible book using one of the plurality of book selection keys 112, the selected book name will preferably appear on the displayed book identifier 122 of display screen 118, as shown. The displayed chapter identifier 122 will indicate, as a preferred system default, the number “1”, indicating to the user that the first chapter of the book has been displayed within the text display area 120, as shown. Similarly, the displayed verse identifier 126 will also indicate, as a preferred system default, the number “1”, indicating to the user that the first verse of the chapter has been displayed in the text display area 120, as shown. Preferably, the desired chapter and verse of the selected Bible Book may now be selected, either by using the scroll control keys 128 to increment or decrement the chapter and verse until the desired scripture is present in the text display area 120, or by entering the desired chapter number and verse number using numeric keypad 138. The respective chapter and verse selected by either method will also preferably be displayed in the displayed chapter and verse identifiers 124 and 126.

FIG. 3 is a front view of the system, in a closed position, according to a preferred embodiment of the present invention. In the view of FIG. 3, the front external housing 142 (herein embodying at least one-hand-holdable housing) comprising the outer surface of book selection section 104 is shown. Preferably, system 100 is, in the closed position, essentially rectangular, comprising six adjoining surfaces, preferably with smoothly rounded adjoining edges and corners, as shown. It should be noted that under appropriate circumstances, system 100 can take other physical shapes to meet specific user needs or design considerations. A preferred embodiment of the present invention has a preferred length of about six inches and preferred width of about three and one half inches (when in the closed position). Those skilled in the art will recognize that under appropriate circumstances, other dimensional arrangements of system 100 may be preferred. For example, a larger unit for the visually impaired may be produced to allow larger size viewable text on the input keys as well as on the display screen 118. A similar unit of increased size, having large and colorful input keys, may be desirable for use by younger children. In such cases, system 100 may comprise the preferred length and width of about twelve inches high by about seven inches wide (when in the closed position). Identifying indicia 143, including titles and symbols may preferably be imprinted on the front external housing 142, as shown.

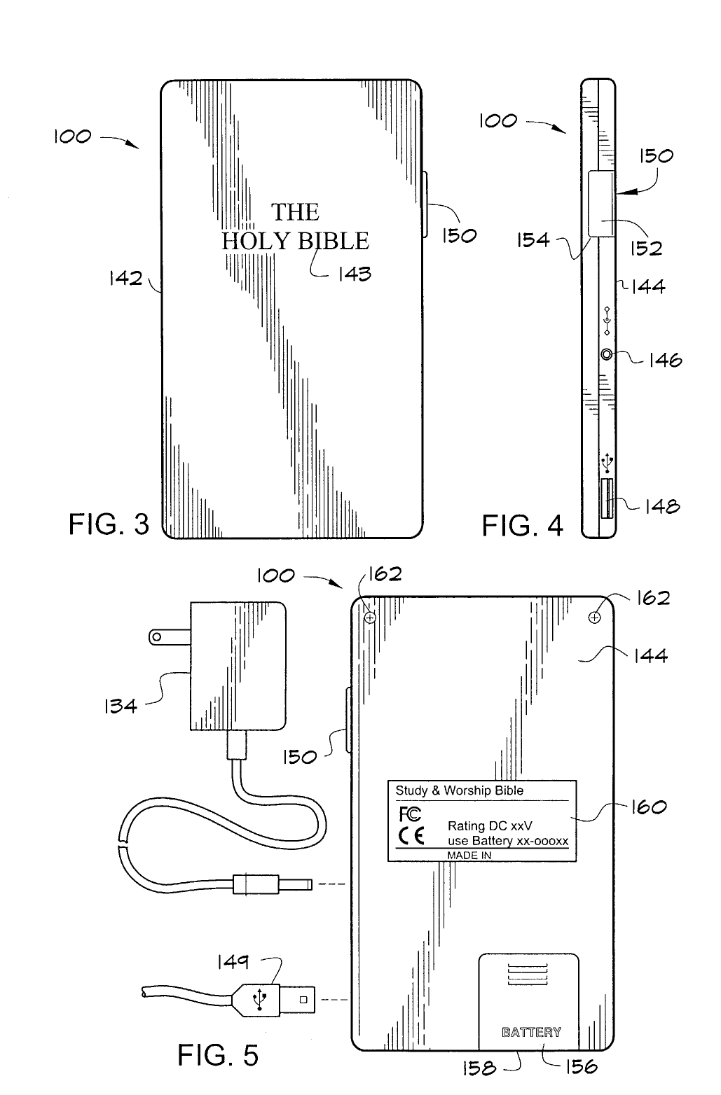

FIG. 4 is a side view of system 100, in a closed position, according to a preferred embodiment of the present invention. Preferably, system 100 has a thin, or narrow, on-edge aspect that is easily carried, stored and used. As shown, the thickness of system 100 (in the closed position) is about ⅝″. Visible in FIG. 4 is the rear external housing 144 (herein embodying at least one hand-holdable housing) comprising the outer surface of display and control section 106. Preferably, rear external housing 144 further comprises at least one A/C power adapter port 146 and at least one data port, preferably USB port 148 (herein embodying at least one data-transferring component), as shown. Identifying indicia are preferably printed or molded into the exterior surface of the rear external housing 144 near each of their respective ports, as shown.

Preferably, located opposite the hinge assembly 108 is at least one clasp assembly 150, as shown. The clasp assembly 150 preferably comprises a clasp tab 152 integrally formed with the outer peripheral edge of the rear external housing 144, and a clasp tab receiver socket 154 integrally formed with the outer peripheral edge of the front external housing 142, as shown. Preferably, clasp tab 152 and clasp tab receiver socket 154 are adapted to releaseably interlock when the two housing sections of system 100 are in the closed (shut) position, thus forming a locked but releasable closure therebetween. Under appropriate circumstances, other suitable clasping/latching arrangements to secure system 100 may be suitable.

FIG. 5 is a rear view of system 100, in a closed position, according to a preferred embodiment of the present invention. Preferably, rear external housing 144 comprises at least one battery access panel 156, as shown. Preferably, battery access panel 156 is adapted to removably engage rear external housing 144 by means of at least one snap-in engagement. Battery access panel 156 is preferably adapted to protectively cover at least one battery compartment 158 (located directly below battery access panel 156). Those skilled in the art will appreciate that battery compartment 158 may comprise one of several well-known designs used in consumer electronics, adapted to retain at least one replaceable battery. Preferably, battery compartment 158 is integrally molded with rear external housing 144; however, under appropriate circumstances, other configurations, including independently molded assemblies, may suffice. At least one informational label 160 may be applied to rear external housing 144, indicating location of manufacture, testing agency certification, power and battery requirements, etc. Preferably, system 100 is designed to be serviceable and is designed to allow the external and internal assemblies to be accessed, removed and replaced by a qualified person. Preferably, to join and retain the internal and external sub-assemblies of system 100, at least one housing retention screw 162 is preferably located at the periphery of rear external housing 144, as shown.

It is presently preferred that both the front external housing 142 and rear external housing 144 of system 100 comprise at least one durable and lightweight material, such as rigid plastic, preferably, molded PVC. In a preferred embodiment of the present invention, at least one portion of the external housings, under appropriate circumstances, may be covered with an outer decorative covering comprising a material or a combination of materials, such as leather, vinyl, rubber or cloth. Additionally, under appropriate circumstances, at least one portion of front external housing 142 and rear external housing 144 may comprise at least one metal, such as aluminum. As previously described, system 100 is adapted to utilize at least one AC adapter 134 to provide power when the user is within convenient distance of an electrical outlet. AC adapter 134 may be supplied with system 100, as part of a consumer kit, or may be optionally available as a purchased upgrade. Similarly, at least one data cable, preferably a USB cable 149 (herein embodying at least one data-transferring component), may be supplied with system 100 as part of a consumer kit, or may be available as an option.

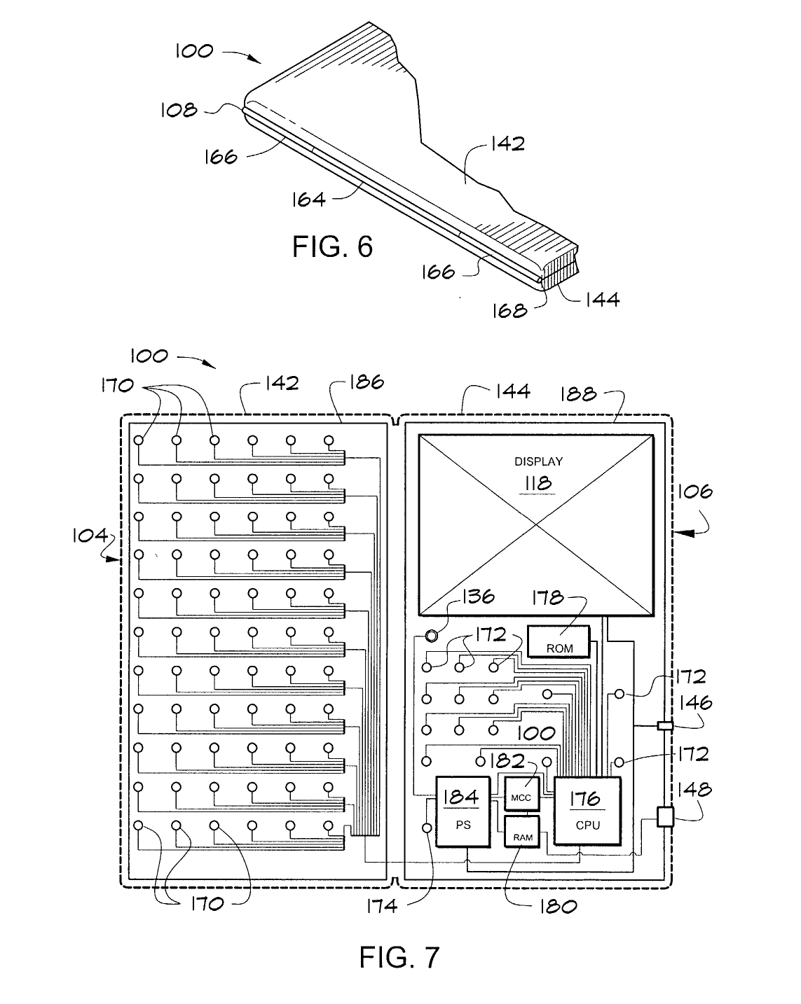

FIG. 6 is a partial perspective view of the system showing the case hinge assembly 108 according to a preferred embodiment of the present invention. The front external housing 142 and rear external housing 144 are preferably joined by at least one hinge assembly 108 that preferably allows housings 142 and 144 to open and close in a book-like manner. The hinge assembly 108 may, under appropriate circumstances, be of any suitable type and may be located at any preferred position along the peripheral edge of the front external housing 142 and rear external housing 144. Preferably, the hinge assembly 108 comprises at least one cylindrical first knuckle 164 integrally formed with the front external housing 142, and at least one, preferably two, cylindrical second knuckles 166 integrally formed with the rear external housing 144, as shown. Preferably, the first knuckle 164 is interdigitally positioned between the two second knuckles 166, and at least one pin 168 (preferably comprising the same rigid material as housings 142 and 144) is pressed through the first knuckle 164 and second knuckles 166, thereby pivotally joining two housings 142 and 144, as shown. It will be understood, based on this disclosure, that under appropriate circumstances, the hinge assembly 108 may be formed separately from the front external housing 142 and rear external housing 144 without departing from the scope of the invention. Additionally, other methods of pivotally joining front external housing 142 to rear external housing 144, under appropriate circumstances, may suffice.

Referring to FIG. 7, a preferred component layout and electrical schematic diagram of a portion of the system, including the microprocessor and its display, keypad and nonvolatile memory, is shown according to a preferred embodiment of the present invention. Preferably, system 100 uses a plurality of membrane-type switches, as shown. Each of the preferred membrane switches of system 100 is of a well-known type comprising a thin, three-layered assembly. The upper layer of the membrane switch comprises at least one transparent polycarbonate film having both graphics and conductive pads printed on the under surface; the middle layer comprises a polyester film acting as a spacer; the lower layer comprises at least one printed circuit board into which the switch contacts and interconnections are etched. Contact is made by manually pressing the upper layer against the lower layer. The book selection section 112 preferably comprises at least one book selection membrane switch 170 having a plurality of contact elements positioned beneath the respective keys of the book selection keys 112 (FIG. 2.) The display and control section 106 further preferably comprises at least one control selection membrane switch 172 having a plurality of contact elements positioned beneath the respective keys of the numeric keypad 138, the scroll control keys 128, and the jump control switch 130 (see FIG. 2). The display and control section 106 further preferably comprises at least one power control membrane switch 174 positioned beneath the power on/off switch 132 shown in FIG. 2. Those skilled in the art will recognize that under appropriate circumstances, other types of switches and contact means might be utilized in preferred embodiments of system 100 of the present invention.

System 100 further preferably comprises at least one central processing unit (CPU) 176 (herein embodying at least one processor component structured and arranged to: process at least one signal from such at least one input component; retrieve a user-selected portion of electronically stored Biblical information from such at least one storage component; and display the user-selected portion of electronically stored Biblical information on such at least one display component), or such other type integrated circuit unit for the operation and control of system 100, as shown. System 100 further preferably comprises at least one read-only memory (ROM) 178 that preferably contains the operating system instructions for System 100, as shown. Preferably, ROM 178 is coupled to CPU 176, as shown. System 100 further preferably comprises at least one random-access memory (RAM) 180 (herein embodying at least one storage component structured and arranged to electronically store the Biblical information) that preferably contains a version (or versions) of the Bible text, i.e., The King James Version, the New King James Version, etc. Because RAM 180 is preferably coupled to USB port 148, the connection of system 100 to at least one USB compatible external electronic text source, such as a computer, allows additional versions of The Bible to be downloaded into RAM 180. Preferably, system 100, on detection of USB connection to a compatible computer, begins a “download/setup” routine that includes the display of a “Downloading Text” message on display screen 118, alerting the user that a download routine is in progress. It is also within the scope of the present invention to provide, under appropriate circumstances, at least one wireless data link utilizing, as one example, an infrared data receiver. RAM 180 is preferably coupled to the CPU 176, as shown. System 100 further preferably comprises at least one memory control chip (MCC) 182 preferably coupled to CPU 176 and to RAM 180, as shown. CPU 176 is further preferably coupled to display screen 118, as shown. System 100 preferably comprises at least one power supply 184 preferably coupled to CPU 176, power control membrane switch 174, display screen 118 and the other power dependant components of system 100, as shown. Preferably, power supply 184 comprises one or more replaceable batteries located within battery compartment 158 (shown in FIG. 5). Connecting A/C power adapter 134 (see FIG. 2) to A/C power adapter port 146 preferably allows A/C power adapter 134 to supply power directly to system 100 by bypassing battery power supplied from power supply 184 (battery compartment 158). It is within the scope of the present invention to provide an embodiment of system 100 comprising an arrangement of one or more rechargeable batteries that are periodically renewed by the connection of AC adapter 134. Preferably, the circuit of power supply 184 can be turned off by CPU 176 on detection of a momentary closed condition at power on/off switch 132, or after system 100 has been on for two minutes with no activity.

Preferably, the components comprising the book selection section 104 are contained on at least one book selection printed circuit board 186 secured to the interior of front external housing 142, as shown. Similarly, the components comprising the display and control section 106 are preferably contained on at least one display and control printed circuit board 188, secured to the interior of rear external housing 144, as shown. At least one ribbon cable or similar flexible electronically conductive component is used to join the book selection printed circuit board 186 and the display and control printed circuit board 188, as shown. Those skilled in the art will recognize that under appropriate circumstances other components, circuitry, or switches might be utilized herein.

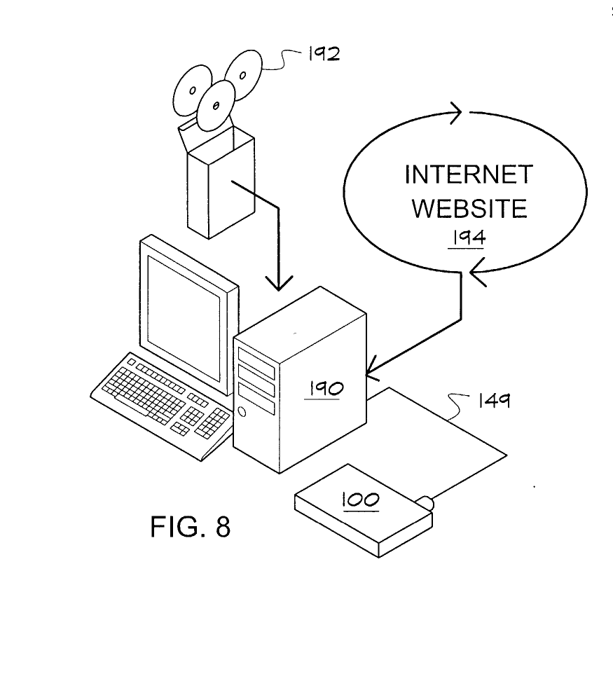

FIG. 8 is a diagram showing the preferred methods a user of system 100 may use to download and install additional biblical text translations according to a preferred embodiment of the present invention. Preferably, at least one biblical text translation, stored on at least one compatible computer 190, or similar electronic device, is downloaded to system 100 using at least one data connection, preferably USB Cable 149, as shown. As previously described, several translations of The Bible may be preferably downloaded and stored in the random-access memory (RAM) 180 of system 100. A user may acquire supplementary versions of The Bible by either of two preferred methods. A user may preferably purchase additional biblical text translations as a consumer package in the form of removable magnetic or optical storage media, such as a compact disk 192. Compact disk 192 (or similar removable storage media) is then used to install the biblical text translations into the memory of computer 190, as shown. If computer 190 is connected to an external network (such as the Internet), the user of system 100 may initiate a purchase and download transaction to install the biblical text translations into the memory of computer 190 by accessing an appropriate Internet web site 194, as shown. Under either of the above-described sourcing methods, the desired biblical text translation is ultimately downloaded to system 100 for portable use.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1) A system for user selection and display of electronically stored Biblical information comprising:
a) at least one storage component structured and arranged to electronically store the Biblical information;
b) at least one input component structured and arranged to assist user input;
c) at least one display component structured and arranged to display the electronically stored Biblical information; and
d) at least one processor component structured and arranged to:
i) process at least one signal from said at least one input component;
ii) retrieve a user-selected portion of electronically stored Biblical information from said at least one storage component; and
iii) display the user-selected portion of electronically stored Biblical information on said at least one display component;
e) at least one hand-holdable housing structured and arranged to house said at least one storage component, said at least one input component, said at least one processor component and said at least one display component;
f) wherein said at least one input component comprises a plurality of dedicated actuators;
g) wherein each respective said dedicated actuator is structured and arranged to select a single respective one Bible book by a single user actuation; and
h) wherein each said dedicated actuator selects one of 66 Bible books for display.

2) The system according to claim 1 further comprising:
a) at least one chapter selection component structured and arranged to assist user selection of at least one chapter of at least one electronically stored Bible book; and
b) at least one verse selection component structured and arranged to assist user selection of at least one verse of at least one chapter of at least one electronically stored Bible book.

3) The system according to claim 1 further comprising:
a) at least one user entry recording component structured and arranged to electronically record at least one string of sequential user entries; and
b) at least one toggle selection component structured and arranged to assist the user in sequentially toggling between displays of the electronically recorded entries of the at least one string of sequential user entries.

4) The system according to claim 1 further comprising at least one numeric input component structured and arranged to assist user numeric input of at least one chapter and at least one verse of at least one electronically stored Bible book.

5) The system according to claim 1 further comprising at least one data-transferring component structured and arranged to transfer electronic Biblical information contained within at least one separate electronic device, to said system.

6) The system according to claim 2 further comprising:
a) at least one user entry recording component structured and arranged to electronically record at least one string of sequential user entries;
b) at least one toggle selection component structured and arranged to assist the user in sequentially toggling between displays of the electronically recorded entries of the at least one string of sequential user entries;
c) at least one numeric input component structured and arranged to assist user numeric input of at least one chapter and at least one verse of at least one electronically stored Bible book; and
d) at least one data-transferring component structured and arranged to transfer electronic Biblical data, contained within at least one separate electronic device, to said system.

7) The system according to claim 6 wherein said at least one hand-holdable housing further comprises:
a) at least one front housing section;
b) at least one rear housing section; and
c) at least one pivot structured and arranged to pivotally join said at least one front housing section to said at least one rear housing section.

8) The system according to claim 7 further comprising at least one power supply structured and arranged to supply power to said system.

9) The system according to claim 8 wherein said at least one power supply comprises at least one on-board battery to assist in portability.

10) The system according to claim 8 wherein said at least one power supply comprises at least one A/C adapter.

11) The system according to claim 8 further comprising at least one power controller structured and arranged to control the power of said system.

12) The system according to claim 11 wherein said at least one power controller comprises:
a) at least one user controlled switch; and
b) at least one automatic switch controlled by said at least one processor;
c) wherein said at least one processor, on detecting a predefined period of inactive use of said system, opens said automatic switch to conserve capacity of said at least one power supply.

13) The system according to claim 12 wherein said at least one display comprises:
a) at least one text display area structured and arranged to display the selected electronic Biblical information;
b) at least one displayed book identifier area structured and arranged to identify the selected Biblical book;
c) at least one displayed chapter identifier area structured and arranged to identify at least one selected chapter of at least one selected Biblical book; and
d) at least one displayed verse identifier area structured and arranged to identify at least one selected verse of at least one selected chapter of at least one selected Biblical book.

14) The system according to claim 13 wherein:
a) said at least one dedicated actuator comprises at least one key comprising at least one membrane switch.

15) The system according to claim 14 wherein:
a) said at least one chapter selection component comprises at least one scrollable key; and
b) said at least one verse selection component comprises at least one scrollable key.

16) A method, using a hand-holdable electronic system, for user selection and display of electronically-stored Biblical information, comprising selecting a respective Bible book by performing a respective single user-actuation of a respective dedicated selection actuator.

17) The method according to claim 16 further comprising:
a) selecting a desired Bible chapter by performing at least one user input, using at least one scrollable Bible chapter selection component, whereby the selected Bible chapter is displayed; and
b) selecting a desired Bible verse by performing at least one user input, using at least one scrollable Bible verse selection component.

18) The method according to claim 16 further comprising:
a) selecting a Bible version from a displayed list; and
b) selecting a desired Bible chapter and verse by performing at least one user input, using at least one numeric input component.

19) A method for acquiring at least one supplemental electronic copy of Biblical information for storage and use with at least one system for user selection and display of electronically stored Biblical information, comprising the steps of:
a) transacting with at least one electronic Biblical information source to acquire such at least one electronic copy of Biblical information;
b) receiving such at least one electronic copy of Biblical information for storage on at least one separate electronic device; and
c) transferring such at least one electronic copy of Biblical data, contained within such at least one separate electronic device, to said system.

20) The system according to claim 19 wherein:
a) such transacting comprises at least one retail purchase of at least one electronic copy of Biblical information; and
b) such at least one electronic copy of Biblical information comprises at least one electronic storage media.

21) The system according to claim 19 wherein:
a) transacting comprises at least one Internet-based purchase of such at least one electronic copy of Biblical information; and such at least one electronic copy of Biblical information is electronically transferred, from at least one Internet-based site, to such at least one separate electronic device.
